(19) United States
(12) Patent Application Publication
(10) Pub. No.: US 2020/0004533 A1
(43) Pub. Date: Jan. 2, 2020

(54) HIGH PERFORMANCE EXPRESSION EVALUATOR UNIT

(71) Applicant: Microsoft Technology Licensing, LLC, Redmond, WA (US)

(72) Inventor: Charles Neill Boyd, Woodinville, WA (US)

(21) Appl. No.: 16/024,189

(22) Filed: Jun. 29, 2018

(51) Int. Cl. G06F 9/30

(52) U.S. Cl. CPC G06F 9/3001; G06T 1/20; G06F 9/30101

(57) ABSTRACT

Devices and methods for limiting register usage through the use of fixed function processing is provided. The method may include receiving instructions executable by a processor. The method may also include that a set of the instructions is executable according to a restricted register mode when the set of the instructions relate to one or more single function operations, wherein the restricted register mode includes only a single access or no access to a register. The method may further include executing, by an expression evaluator, operations of the set of the instructions related to the one or more single function operations, wherein the executing is performed in the restricted register mode and in parallel with the processor performing additional operations of the instructions.

### BACKGROUND

The following disclosure relate to a computer device, and in particularly, to a high performance expression evaluator unit used in a computer device.

In many computer systems, a processor performs algorithms which include multiple instructions. In some computer systems, a parallel processing unit, such as a single instruction multiple data (SIMD) unit processor, may be used to perform multiple instructions in parallel with each other. A SIMD processor receives a single instruction for simultaneously performing on multiple data points. A SIMD processor may be used by, for example, a graphics processing unit (GPU) when adjusting the contrast, brightness, or color of an image. For many years, processor manufacturers were able to increase the speed of a processor, such as a SIMD processor, by implementing processors with more transistors. Processor manufacturers were able to consistently diminish a size of the processor according to Moore's law, which predicted that the number of transistors within a processor would at least double each year without increasing the size of the processor. However, in recent years, the ability to meet Moore's law has become increasingly difficult due to the heating and communication restrictions within a processor. Processor manufactures have therefore resorted to other avenues to increase the overall speed of the processor. In particular, many processor manufacturers look towards increasing the efficiency of the processor and the processes performed by the processor.

Therefore, there is a need in the art for more efficient processors in a computer device.

### SUMMARY

The following presents a simplified summary of one or more examples in order to provide a basic understanding of such examples. This summary is not an extensive overview of all contemplated examples, and is intended to neither identify key or critical elements of all examples nor delineate the scope of any or all examples. Its sole purpose is to present some concepts of one or more examples in a simplified form as a prelude to the more detailed description that is presented later.

One example relates to a method of computer processing. The method may include receiving instructions executable by a processor. The method may also include determining, by the processor, that a set of instructions of the received instructions is executable according to a restricted register mode in which the set of instructions relate to one or more single function operations that require no access to a register during execution of the one or more single function operations. The method may further include executing, by an expression evaluator, operations of the set of instructions related to the one or more single function operations, wherein the executing is performed in the restricted register mode and in parallel with the processor performing arithmetic logic unit (ALU) operations of the instructions.

Another example relates to a computer system. The computer system may include a processor and an expression evaluator coupled with the processor. The expression evaluator may be configured to receive a first set of instructions from the processor, the first set of instructions executable according to a restricted register mode in which the set of instructions relate to one or more single function operations that require no access to a register during execution of the one or more single function operations. The expression evaluator may also be configured to execute operations of the first set of instructions in the restricted register mode and in parallel with the processor executing operations of a second set of instructions. The expression evaluator may further be configured to send a final result to the processor based on the executed operations of the first set of instructions.

Another example relates to a computer-readable storage medium storing instructions for computer processing, the instructions executable by one or more processors. The computer-readable storage medium may include at least one instruction for causing a processor to receive restricted register instructions executable by a processor. The computer-readable storage medium may also include at least one instruction for causing the processor to determine that a set of instructions of the restricted register instructions is executable according to a restricted register mode in which the set of instructions relate to one or more single function operations that require no access to a register during execution of the one or more single function operations. The computer-readable storage medium may further include at least one instruction for causing the processor to execute operations of the set of instructions related to the one or more single function operations, wherein the executing is performed in the restricted register mode and in parallel with the processor performing additional operations of the restricted register instructions, wherein the executing is performed in the restricted register mode and in parallel with the processor performing additional operations of the restricted register instructions.

To the accomplishment of the foregoing and related ends, the one or more examples comprise the features hereinafter fully described and particularly pointed out in the claims. The following description and the annexed drawings set forth in detail certain illustrative features of the one or more examples. These features are indicative, however, of but a few of the various ways in which the principles of various examples may be employed, and this description is intended to include all such examples and their equivalents.

### DESCRIPTION OF THE DRAWINGS

FIG. 1 is a schematic block diagram of an example architecture of a computer device including a graphics processing unit and a graphics pipeline configured according to the described examples;

FIG. 2 is a schematic diagram of an example of the processor of the computer device of FIG. 1;

FIG. 3 is a diagram of an example of a pipelined architecture for implementing an expression evaluator in a graphics architecture according to the described examples;

FIG. 4 is a flowchart of an example of a method of rendering an image based on operation of the graphics pipeline to generate outputs to a render target according to the described examples; and

FIG. 5 is a schematic block diagram of an example computer device in accordance with an implementation of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

In general, algorithms, such as those used for three-dimensional (3D) graphics generation or artificial intelligence (AI), benefit from parallel processing through the use of flexible programmable functions. Processors, such as single instruction multiple data (SIMD) or a single program multiple data (SPMD) processors, are able to perform large amounts of algorithms applied to larger amounts of data points. These processors may require the use of a large number of registers to process the algorithms such that every instruction performed requires the processor to use multiple input ports (e.g., 3 or more) for processing input data and an output port for writing results of instructions. These ports typically require switches/muxes for distributing and routing inputs to/from different registers within a computer system. Further, each of the switches/muxes may have multiple wires for connecting to the registers and the processors. In essence, modern processors may be limited by register file bandwidth or power requirements as all of the registers, switches/muxes, and wires used for programmable functions may require a significant amount of space within a processor die and/or be cost prohibitive and/or may require power or cooling resources beyond those available on a device.

For certain types of algorithms, or portions of an algorithm, the generality of a programmable architecture is not needed. These types of algorithms may be simple expressions having single operations, where data does not need to come from arbitrary locations (e.g., registers) for the processors to perform the operation because data within these types of algorithms is constant. These types of operations may include, but are not limited to, leaf-node code or inner loop computations that require minimal register input/output. However, because these types of algorithms are processed by the programmable architecture, the data is processed through multiple registers and consumes an unnecessary amount of processing power.

This disclosure describes various examples related to an expression evaluator for limiting register use through the use of fixed function processing. The expression evaluator may be used to load data as part of an instruction itself, or the data may be placed in a special type of register pool, so that the data is only specifically routable to a specific location without the use of switches/muxes.

In an aspect of the present disclosure, a graphics processing unit (GPU) may receive instructions for performing graphics operations (e.g., shader operations). The instructions may be received by the GPU from another processor such as a control processing unit (CPU) or another GPU or from a memory device. Once received, the GPU may read and operate on operations related to the instructions.

The GPU may include a processor such as a SIMD processor which receives the instructions for parallel processing. The SIMD processor may operate on some of the instructions and also determine that some of the instructions include operations that are executable according to a restricted register mode. In an example, a restricted register mode is a mode in which the operations are single function operations that require limited (e.g., only a single access or no access) access to a register during performance of the operations. These operations may include mathematical operands or single register operands such as add, multiply, absolute value or any other single function operation for operating on a constant.

In an example, the SIMD may determine that some of the instructions include operations that are executable according to the restricted register mode based on whether the instructions include a special syntax such as comments within code or a specific instruction which explicitly designates a set of the instructions for being executable according to a restricted register mode. In another example, the SIMD may determine that some of the instructions include operations that are executable according to a restricted register mode based on the instructions including one or more single function operations which are executable according to a restricted register mode. In other words, the SIMD may look at each operation of the instructions to make the determination.

Once determined, the SIMD processor may send the set of the instructions related to the single function operations to an expression evaluator to operate on the set of the instructions. The expression evaluator may execute operations of the set of the instructions with limited access to registers. This means the expression evaluator may perform all of the operations of the set of the instructions with no access to a register before returning a final result to the SIMD processor. In an example, the expression evaluator may receive a constant with the instructions and begin to operate according to operations of the set of the instructions based on the constant. In an simplistic example, the expression evaluator may receive instructions having a constant equal to 6 and operations including add by 4, multiply by 3, subtract 6. According to this example, the expression evaluator adds 4 to 6 (result equals 10), then multiplies 3 by 10 (result equals 30), and then subtracts 6 from 30 (result equals 24) to reach the final result of 24. As each of the operations are single function operations, the expression evaluator may obtain the final result (e.g., 24) by performing all of the operations of the set of instructions without accessing a register.

As such, the SIMD processor may operate or manage the operation of one or more remaining sets of instructions while the expression evaluator executes the received set of instructions. The expression evaluator may also reduce the number of registers and/or switches/muxes required to be used by the SIMD processor, as the expression evaluator may operate on sets of instructions without the need for registers, thus eliminating multiple wires for connecting between the SIMD processor and the registers and switches/muxes.

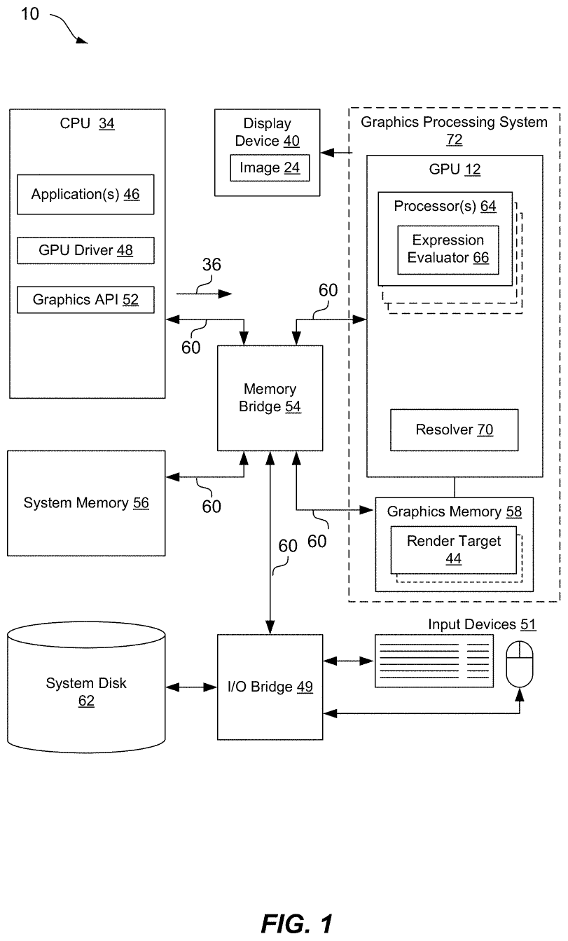

Referring to FIG. 1, in one example, a computer device 10 includes a GPU 12 configured to implement the described examples for limiting register use through the use of one or more expression evaluators 66. For example, the GPU 12 can be configured to receive instructions including data that are executable by the GPU. The GPU 12 may also be configured to determine, by the processor, that a set of instructions is executable according to a restricted register mode when the set of instructions includes one or more single function operations. In an example, the restricted register mode is a mode in which operations are performed by the GPU 12 with limited access to registers. The GPU 12 may further be configured to execute, by the expression evaluator 66, the set of instructions according to the one or more single function operations based on determining the set of instructions is executable according to the restricted register mode, wherein the executing is performed in parallel with the processor performing additional operations on the instructions. By having the expression evaluator 66 execute the first set of instructions, the GPU 12 may execute a second set of the instructions in parallel with the first set of instructions. Further, because the first set of instructions includes one or more single function operations, the expression evaluator 66 may operate on the first set of instructions with limited to no use of registers. Use of the expression evaluator 66 may accelerate the code blocks, for example but not limited to, by 4-10 times, due to the lack of use of registers, as compared to these same operations being performed by a processor (e.g., a SIMD) with the standard use of registers and allow the processor to perform general operations while the expression evaluator 66 focuses on the single function operations. Further, the use of the expression evaluator 66 may result in minimal cost in power and die area because fewer registers are needed for these types of operations. Implementation of the expression evaluator 66 may allow, for example, the GPU 12 to use the single function operations as a class of lambda or macro expressions in a high level shader language (HLSL).

Examples of the single function operations may include single mathematical operands or single register operands including, but not limited to copy, minimum (min), maximum (max), add, multiply (mul), absolute value (abs), reciprocal (rcp), square root (sqrt), reciprocal square root (rsq), log, exponential (exp), dot product, fraction (frac), conditional operator bits, Phi operators, floating point modulo/remainder (fmod), negate, sign function (sgn), or any other single function operation for operating on a constant.

Some examples of applications that may benefit from use of the expression evaluator 66 may include a material/lighting math for a rasterizer or a ray tracer, a simple compositing operation, a color space conversion, a procedural Signed Distance Function (SDF) evaluation, and mathematical operations, such as matrix mathematics, for artificial intelligence (AI) or machine learning (ML).

In one implementation, the computer device 10 includes a CPU 34, which may be one or more processors that are specially-configured or programmed to control operation of the computer device 10 according to the described examples. For instance, the user may provide an input to the computer device 10 to cause the CPU 34 to execute one or more software applications 46. The software applications 46 that execute on the CPU 34 may include, for example, but are not limited to one or more of an operating system, a word processor application, an email application, a spread sheet application, a media player application, a video game application, a graphical user interface application, or another program. Additionally, the CPU 34 may include a GPU driver 48 that can be executed for controlling the operation of the GPU 12. The user may provide input to the computer device 10 via one or more input devices 51 such as a keyboard, a mouse, a microphone, a touchpad, or another input device that is coupled with the computer device 10 via an input/output (I/O) bridge 49, such as but not limited to a southbridge chipset or integrated circuit.

The software applications 46 that execute on the CPU 34 may include one or more instructions that executable to cause the CPU 34 to issue one or more graphics commands 36 to cause the rendering of graphics data associated with an image 24 on a display device 40. In some implementations, the software application 46 may place the graphics commands 36 in a buffer in the system memory 56 and a processor 64 of the GPU 12 fetches them. In some examples, the software instructions may conform to a graphics application programming interface (API) 52, such as, but not limited to, a DirectX and/or Direct3D API, an Open Graphics Library (OpenGL®) API, an Open Graphics Library Embedded Systems (OpenGL ES) API, an X3D API, a RenderMan API, a WebGL API, or any other public or proprietary standard graphics API. In order to process the graphics rendering instructions, the CPU 34 may issue the graphics commands 36 to the GPU 12 (e.g., through GPU driver 48) to cause the GPU 12 to perform some or all of the rendering of the graphics data.

The computer device 10 may also include a memory bridge 54 in communication with the CPU 34 that facilitates the transfer of data going into and out of the system memory 56 and/or the graphics memory 58. For example, the memory bridge 54 may receive memory read and write commands, and service such commands with respect to the system memory 56 and/or the graphics memory 58 in order to provide memory services for the components in the computer device 10. The memory bridge 54 is communicatively coupled to the GPU 12, the CPU 34, the system memory 56, the graphics memory 58, and the I/O bridge 49 via one or more buses 60. In an example, for example, the memory bridge 54 may be a northbridge integrated circuit or chipset.

The system memory 56 may store program modules and/or instructions that are accessible for execution by the CPU 34 and/or data for use by the programs executing on the CPU 34. For example, the system memory 56 may store the operating system application for booting the computer device 10. Further, for example, the system memory 56 may store a window manager application that is used by the CPU 34 to present a graphical user interface (GUI) on the display device 40. In addition, the system memory 56 may store the software applications 46 and other information for use by and/or generated by other components of the computer device 10. For example, the system memory 56 may act as a device memory for the GPU 12 (although, as illustrated, GPU 12 may generally have a direct connection to its own graphics memory 58) and may store data to be operated on by the GPU 12 as well as data resulting from operations performed by the GPU 12. The system memory 56 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), Flash memory, a magnetic data media or an optical storage media.

Additionally, in an example, the computer device 10 may include or may be communicatively connected with a system disk 62, such as a CD-ROM or other removable memory device. The system disk 62 may include programs and/or instructions that the computer device 10 can use, for example, to boot operating system in the event that booting operating system from the system memory 56 fails. The system disk 62 may be communicatively coupled to the other components of the computer device 10 via the I/O bridge 49.

The GPU 12 may be configured to perform graphics operations to render one or more render targets 44 (e.g., based on graphics primitives) to the display device 40 to form the image 24. For instance, when one of the software applications 46 executing on the CPU 34 requires graphics processing, the CPU 34 may provide graphics commands and graphics data associated with the image 24, along with the graphics command 36, to the GPU 12 for rendering to the display device 40. The graphics data may include, e.g., drawing commands, state information, primitive information, texture information, etc. The GPU 12 may include one or more processors 64, for example a command processor for receiving graphics commands 36 and initiating or controlling the subsequent graphics processing by a primitive processor for assembling primitives, a graphics shader processor for processing vertex, surface, pixel, and other data for GPU 12, a texture processor for generating texture data for fragments or pixels, or a color and depth processor for generating color data and depth data and merging the shading output. The GPU 12 may, in some instances, be built with a highly parallel structure that provides more efficient processing of complex graphic-related operations than the CPU 34. For example, the GPU 12 may include a plurality of processing elements that are configured to operate on multiple vertices or pixels in a parallel manner. The highly parallel nature of the GPU 12 may, in some instances, allow the GPU 12 to draw the image 24 onto the display device 40 more quickly than drawing the image 24 directly to the display device 40 using the CPU 34.

The GPU 12 may, in some instances, be integrated into a motherboard of the computer device 10. In other instances, the GPU 12 may be present on a graphics card that is installed in a port in the motherboard of the computer device 10 or may be otherwise incorporated within a peripheral device configured to interoperate with the computer device 10. The GPU 12 may include one or more processors, such as one or more microprocessors, application specific integrated circuits (ASICs), field programmable gate arrays (FPGAs), digital signal processors (DSPs), or other equivalent integrated or discrete logic circuitry.

In an example, the GPU 12 may be directly coupled with the graphics memory 58. For example, the graphics memory 58 may store any combination of buffers, such as index buffers, vertex buffers, texture buffers, depth buffers, stencil buffers, render target buffers, frame buffers, state information, shader resources, constants buffers, coarse shading rate maps, unordered access view resources, graphics pipeline stream outputs, or the like. As such, the GPU 12 may read data from and write data to the graphics memory 58 without using the bus 60. In other words, the GPU 12 may process data locally using storage local to the graphics card, instead of the system memory 56. This may allow the GPU 12 to operate in a more efficient manner by eliminating the need of the GPU 12 to read and write data via the bus 60, which may experience heavy bus traffic. In some instances, however, the GPU 12 may not include a separate memory, but instead may utilize the system memory 56 via the bus 60. The graphics memory 58 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), Flash memory, a magnetic data media or an optical storage media.

The CPU 34 and/or the GPU 12 may store rendered image data, e.g., render targets 44, in a render target buffer of the graphic memory 58. The GPU 12 may further include a resolver component 70 configured to retrieve the data from a render target buffer of the graphic memory 58 and convert multisample data into per-pixel color values to be sent to the display device 40 to the display image 24 represented by the rendered image data. In some examples, the GPU 12 may include a digital-to-analog converter (DAC) that is configured to convert the digital values retrieved from the resolved render target buffer into an analog signal consumable by the display device 40. In some examples, the GPU 12 may pass the digital values to display device 40 over a digital interface, such as a High-Definition Multi-media Interface (HDMI interface) or a DISPLAYPORT interface, for additional processing and conversion to analog. As such, in some examples, the combination of the GPU 12, the graphics memory 58, and the resolver component 70 may be referred to as a graphics processing system 72.

The display device 40 may include a monitor, a television, a projection device, a liquid crystal display (LCD), a plasma display panel, a light emitting diode (LED) array, such as an organic LED (OLED) display, a cathode ray tube (CRT) display, electronic paper, a surface-conduction electron-emitted display (SED), a laser television display, a nanocrystal display or another type of display unit. The display device 40 may be integrated within the computer device 10. For instance, the display device 40 may be a screen of a mobile telephone. Alternatively, the display device 40 may be a stand-alone device coupled to the computer device 10 via a wired or wireless communications link. For instance, the display device 40 may be a computer monitor or flat panel display connected to a personal computer via a cable or wireless link.

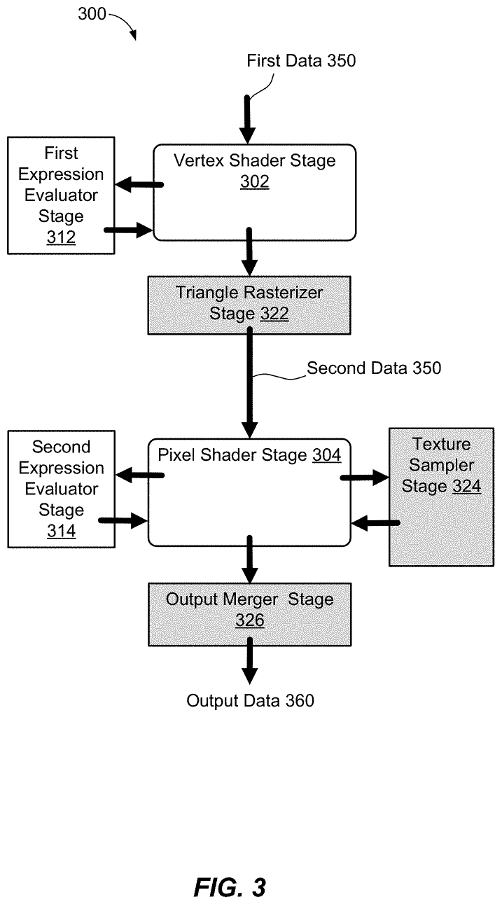

According to one example of the described examples, the graphic API 52 and the GPU driver 48 may configure the GPU 12 to execute a graphics pipeline (see e.g., 300 of FIG. 3) to perform shader processes, as described herein.

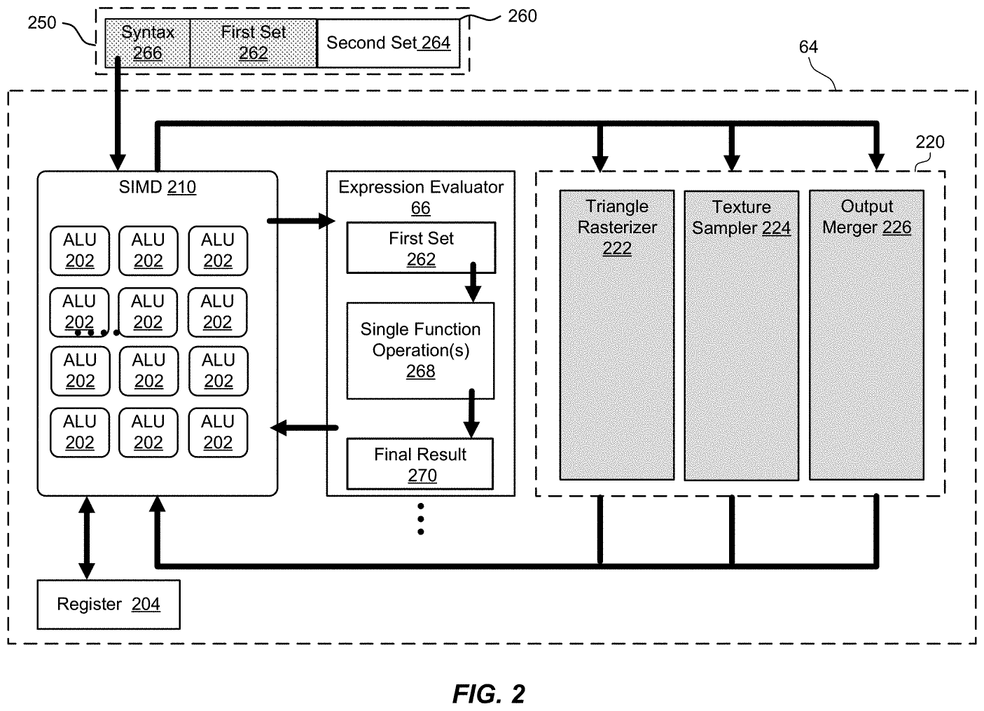

Referring to FIG. 2, in an example, the processor 64 of the GPU 12 may be configured as a single instruction multiple data (SIMD) processor 210 for a parallel computing. The SIMD processor 210 may simultaneously perform the same operation on multiple data points. For example, the SIMD processor 210 may adjust contrast, brightness, or color of the image 24.

The processor 64 may include an array of arithmetic logic units (ALUs) 202 configured for performing the simultaneous instructions. Each of the ALUs 202 may be used as a shader ALU, such as a vertex shader ALU, a pixel shader ALU, a hull shader ALU, a domain shader ALU, or a geometry shader ALU. In an example, the processor 64 and/or the ALU 202 may be configured to receive data 250 having instructions 260. In an example, the instructions 260 may be for performing a shader function. In an example, the data 250 may be received from the CPU 34. In another example, the data 250 may be received from any one of the ALUs 202 or fixed function units 220.

The processor 64 and/or the ALU 202 may be configured to determine whether a first set of instructions 262 of the instructions 260 is executable according to a restricted register mode. The first set of instructions 262 may include some and/or all instructions within the data 250 that is executable according to the restricted register mode. The restricted register mode may be a mode in which the first set of instructions 262 includes one or more single function operations 268, such as single mathematical operands or single register operands, to be performed on a constant with limited use of registers and/or associated with and directly linked to a special register. In this disclosure, limited use of a register means that the expression evaluator 66 may receive the first set of instructions 262 from the register and/or a constant from the register and perform operations on the first set of instructions 262 without the use of the register until a final result of all operations is determined.

Examples of the first set of instructions 262 may include matrix math operations including convolutions for machine learning, math operations for font rendering, or SDF computations. Examples of the single function operations 268 may include, but are not limited to, copy, minimum (min), maximum (max), add, multiply (mul), absolute value (abs), reciprocal (rcp), square root (sqrt), reciprocal square root (rsq), log, exponential (exp), dot product, fraction (frac), or any other single function operation 268 for operating on a constant.

The processor 64 and/or the ALU 202 may determine whether the first set of instructions 262 is executable according to the restricted register mode based on determining the first set of instructions 262 includes the one or more single function operations 268. In some examples, the processor 64 and/or the ALU 202 may determine whether the first set of instructions 262 is executable according to the restricted register mode based on special syntax 266 within the data 250 or the instructions 260, which explicitly designates the first set of instructions 262 having the one or more single function operations 268. For example, a comment section of the instructions 260 or the first set of instructions 262 itself may declare that the first set of instructions 262 is executable according to the restricted register mode or that the first set of instructions 262 is to be evaluated by the expression evaluator 66.

When the processor 64 and/or the ALU 202 determines that the first set of instructions 262 is executable according to the restricted register mode, the processor 64 and/or the ALU 202 sends the first set of instructions 262 to the expression evaluator 66.

The expression evaluator 66 may be configured to receive the first set of instructions 262 from the processor 64 and/or the ALU 66 and operate on a constant according to the one or more single function operations 268. In some examples, the first set of instructions 262 may include a constant for the expression evaluator 66 to operate on according to the one or more single function operations 268. In other examples, the constant may be received from a register pool designated for communication with the expression evaluator 66. For example, the processor 64 may include the register 204 which is in communication with the expression evaluator 66 via the SIMD 210. The register 204 may provide the constant to the expression evaluator 66 for execution of the one or more single function operations 268. The expression evaluator 66 may use the register 204 after having operated on the first set of instructions 262 received from the SIMD 210.

Once the expression evaluator 66 has completed the one or more single function operations 268, the expression evaluator 66 may send a final result 270 to the SIMD 210. In an example, the expression evaluator 66 may operate on the first set of instructions 262 through a number of clock cycles (e.g., 20 clock cycles), according to operations of the one or more single function operations 268. During this time, the expression evaluator 66 may have limited use of registers or may use a special register, as results of each of the individual single function operations 268 may be used by other single function operations 268 until the final result 270 is reached.

While the expression evaluator 66 executes the one or more single function operations 268, the SIMD 66 may, in parallel with the expression evaluator 66, execute one or more other sets of instructions (e.g., second set of instructions 264) of the instructions 260 and/or coordinate one or more fixed function units 220 to execute one or more other sets of instructions (e.g., second set of instructions 264) of the instructions 260. When the SIMD 66 receives the final result 270 from the expression evaluator 66, the SIMD 66 may use the final result 270 in executing one or more other sets of instructions (e.g., second set of instructions 264) of the instructions 260 and/or send the final result 270 to the one or more fixed function units 220 for performing additional operations. In an example, the one or more fixed function units 220 may include one or more of a triangle rasterizer 222, a texture sampler 224, or an output merger 226, as shown in FIG. 2. However, in other examples, the one or more fixed function units 220 may include one or more of a ray-box intersector or a ray-triangle intersector.

In an example, the expression evaluator 66 may be 64-bit expression evaluator that receives as input two 32-bit values or four 16-bit values and outputs one 32-bit value or two 16-bit values. In some examples, the expression evaluator 66 may perform a micro-instruction count of at least four instructions and if determined that more instructions exist with no register use, then the expression evaluator 66 may perform these instructions.

An example of the first set of instructions 262 having the one or more single function operations 268 may include the SDF computation code below. In this example, the input (e.g., one or more constants received with the first set of instructions 262) of the expression evaluator 66 may include three 16-bit values representing a point in space.

| // parameters: | |
|---|---|
| // input half3 pos | // xyz position to evaluate SDF at (from registers) |

| | |
|---|---|
| // output result | // value of SDF at point ‘pos'. (to registers) |

| | |
|---|---|
| // const half3 box | // dimensions of the box (half-widths) |

| | |
|---|---|
| // const half rad | // radius of curvature of the beveled edges |

// “const” indicates parameters that are uniform and can be encoded as

immediates.

// i.e. in the instruction stream of the evaluator unit (aka uniform)
// Parameters not so labeled read or write the register file of the main

ALU.

| | |
|---|---|
| [[evaluator64:warn]] | // warn if this routine does not fit in a 64-bit |

evaluator

| | |
|---|---|
| [[evaluator128:fail]] | // fail compile if this routine does not fit in a 128- |

bit evaluator

float sdfRoundedBox( half3 pos, const half3 box, const half radius )
{

return length( max( abs(pos) − box, 0.0 ) ) − rad;

}

An expansion of the example SDF computation code above is provided to clarify the routine.

| // Assembly Pseudo Code | |
|---|---|
| half3 R; | // the intermediate result |

R = abs(pos);
R −= box;
R = max( R, 0.0 );
R.x = dot( R, R );
R.x −= rad;
return R.x;

An another expansion of the example SDF computation code above is provided to show each line of the routine in individual vector elements:

R.x = abs(R.x);
R.y = abs(R.y);
R.z = abs(R.z);
R.x −= box.x;
R.y −= box.y;
R.z −= box.z;
R.x = max(R.x, 0.0);
R.y = max(R.y, 0.0);
R.z = max(R.z, 0.0);
R.x = R.x*R.x;
R.x = R.x + R.y*R.y;
R.x = R.x + R.z*R.z;
R.x −= rad;
return R.x;

For the above example SDF computation code, the output (e.g., the final result 270) of the expression evaluator 66 may include a single scalar (float point 16 or float point 32) of the scalar function at that point. In a typical SIMD that uses registers throughout the computation of the example SDF computation code above, the SIMD may take as long as 5 clock cycles to obtain a final result. However, the expression evaluator 66 may determine the final result 270 of the example SDF computation code above in as little as 1 clock cycle.

In an example, a developer may provide the first set of instructions 262 (e.g., example SDF computation code) to a compiler, such as but not limited to during development of an application designed to use expression evaluator 66. In some examples, the first set of instructions 262 may be a part of data 250 or may be provided by itself. In some examples, the first set of instructions 262 or the data 250 may include the special syntax 266 (e.g., the annotation [[evaluator]] in the example SDF computation code) to indicate that the first set of instructions 262 are to be executed by the expression evaluator 66. The compiler may receive the first set of instructions 262 and verifies that the first set of instructions 262 is executable by the expression evaluator 66. In some examples, the compiler may also optimize the first set of instructions 262 to be performed by the expression evaluator 66. For example, the compiler may edit or revise the first set of instructions 262 such that no registers are needed when the first set of instructions 262 is executed by the expression evaluator 66. If the compiler determines that the first set of instructions 262 are not executable by the expression evaluator 66, the compiler my provide a warning to the developer to revise the first set of instructions 262. When the compiler determines that the first set of instructions 262 are executable by the expression evaluator 262, the first set of instructions 262 may be stored for runtime use.

While implementations herein describe the processor 64 including a single expression evaluator 66, as previously stated, the processor 64 may include one or more expression evaluators 66. In some examples, the processor 64 may include an expression evaluator for each ALU (e.g., 64 ALUs and 64 expression evaluators). In other examples, the processor 64 may include an expression evaluator 66 for two or more ALUs (e.g., 64 ALUs and 32 expression evaluators, 64 ALUs and 16 expression evaluators, or any other combination of ALUs/expression evaluator).

Referring to FIG. 3, an example of stages of a logical graphics pipeline architecture 300 implementing the expression evaluator 66 are described. The graphics pipeline architecture 300 may be implemented by the processor 64 according to data 250 associated with an API, such as the graphics API 52. In describing the stages of the graphics pipeline architecture 300, examples of the data 250 may be referred to as first data 350 and second data 352.

In an example, one or more of the various stages may be programmable to perform shader processes, as described above. Moreover, in an example, common shader cores may be represented by the rounded rectangular blocks. The programmability of shaders makes the graphics pipeline architecture 300 extremely flexible and adaptable. Further, the various stages may also include fixed function stages, such as one or more expression evaluator stages to perform specific functions not performed by the shaders. The fixed functions make the graphics pipeline architecture 300 extremely fast and efficient. The purpose of each of the stages is now described in brief below.

Initially, first data 350 (e.g., triangles, lines, points, and indexes) may be supplied to the pipeline architecture 300. The first data 350 may be supplied from a buffer such as a vertex buffer or an index buffer. At a vertex shader stage 302, the ALUs 202 may receive and process the first data 350. In an example, the ALUs 202 may perform operations on the first data 350 such as transformations, skinning, and lighting.

During the vertex shader stage 302, the ALUs 202 may also determine whether the first data 350 includes instructions (e.g., instructions 260) executable by the expression evaluator 66. In this example, the ALUs 202 may determine that a set of instructions (e.g., first set of instructions 262) of instructions of the first data 350 includes one or more mathematical operations, such as material/lighting math for a rasterizer. The ALUs 202 may also determine that the set of instructions of instructions of the first data 350 is executable by the expression evaluator 66. The ALUs 202 may then send the set of instructions of instructions of the first data 350 to the expression evaluator 66 for processing.

During a first expression evaluator stage 312, the expression evaluator 66 may receive the set of instructions of instructions of the first data 350 from the ALUs 202 used during the vertex shader stage 302 and may operate on the one or more single function operations 268 in the set of instructions of the first data 350. Operations performed by the first expression evaluator stage 312 may be performed in parallel with additional operations performed by the ALUs 202 during the vertex shader stage 302 and/or any other stages of the pipeline architecture 300.

At the triangle rasterizer stage 322, the triangle rasterizer 222 may receive primitives from the ALUs 202. Further, the triangle rasterizer 222 may, for example, clip primitives, prepare primitives for a pixel shader ALU 304, or determine how to invoke pixel shaders.

At the pixel shader stage 304, the ALUs 202 may receive second data 352 which may include interpolated data for primitives and/or fragments, pixel shader settings, etc. and generate per-pixel data, such as color and sample coverage masks. In this example, the ALUs 202 may determine that a set of instructions of the second data 352 includes one or more mathematical operations, such as pixel/texture interpolation or manipulation. Further, the ALUs 202 may determine that the set of instructions of the second data 352 is executable by the expression evaluator 66, and therefore may send the set of instructions of the second data 352 to the expression evaluator 66 for processing. During the pixel shader stage 304, the ALUs 202 may also generate pixel shader values.

During a second expression evaluator stage 314, the expression evaluator 66 may receive the set of instructions of the second data 352 from the ALUs 202 used during the pixel shader stage 304 and may operate on the one or more single function operations 268 in the set of instructions of the second data 352. Operations performed by the second expression evaluator stage 314 may be performed in parallel with additional operations performed by the ALUs 202 during the pixel shader stage 304 and/or any other stages of the pipeline architecture 300.

At the output merger stage 326, the output merger 226 may combine various types of pipeline output data (e.g., pixel shader values, depth and stencil information, and coverage masks) to generate the output data 360 used for generating an image (e.g., image 24) of the graphics pipeline architecture 300.

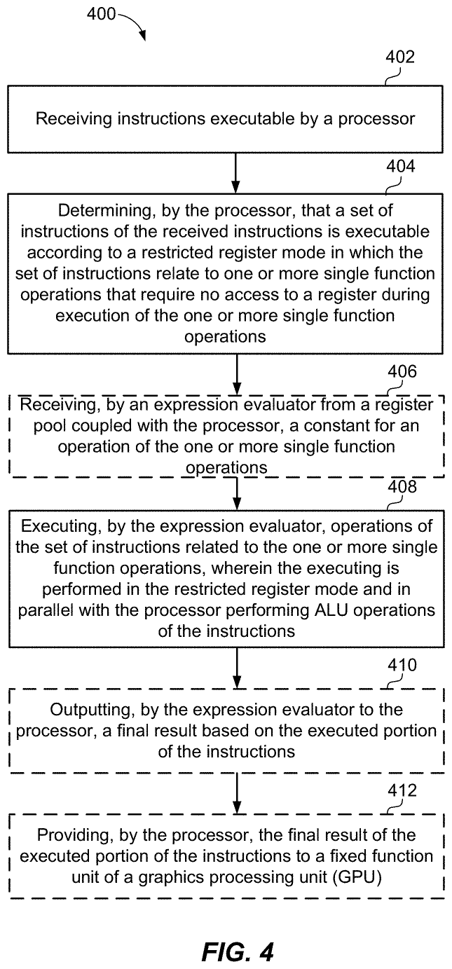

Referring to FIG. 4, a method 400 for implementing an expression evaluator based on examples described above in relation to description of FIGS. 1-3 are provided. The method 400 may be performed by the computer system 10 of FIG. 1.

At block 402, the method 400 may include receiving instructions executable by a processor. For example, as shown by FIGS. 1-3, the processor 64 may receive data 250 having instructions 260. In an example, the data 250 may be used for performing parallel processing. In an example, the data 250 may be received from the CPU 34. In another example, the data 250 may be received from any one of the ALUs 202 or fixed function units 220. In an example, the data 250 may graphics data for generating the image 24 by the GPU 72.

At block 404, the method 404 may include determining, by the processor, that a set of instructions of the received instructions is executable according to a restricted register mode in which the set of instructions relate to one or more single function operations that require no access to a register during execution of the one or more single function operations. For example, the processor 64 and/or the ALU 202 may be configured to determine whether a first set of instructions 262 of the instructions 260 is executable according to a restricted register mode. The processor 64 and/or the ALU 202 may determine whether the first set of instructions 262 is executable according to the restricted register mode based on determining the first set of instructions 262 includes the one or more single function operations 268. In some examples, the processor 64 and/or the ALU 202 may determine whether the first set of instructions 262 is executable according to the restricted register mode based on special syntax 266 within the data 250 or the instructions 260, which explicitly designates the first set of instructions 262 having the one or more single function operations 268.

At block 406, the method 400 may optionally include receiving, from a register pool coupled with the processor, a constant for an operation of the one or more single function operations. For example, as shown by FIG. 2, the processor 64 may include the register 204 which is in communication with the expression evaluator 66 via the SIMD 210. The expression evaluator 66 may receive that constant from the register 204 for execution of the one or more single function operations 268.

At block 408, the method 400 may include executing, by an expression evaluator, operations of the set of instructions related to the one or more single function operations, wherein the executing is performed in the restricted register mode and in parallel with the processor performing arithmetic logic unit (ALU) operations of the instructions. For example, as shown by FIGS. 1-3, the expression evaluator 66 may receive the first set of instructions 262 from the ALUs 202 when the ALUs 202 are in, for example, the vertex shader stage 302 or the pixel shader stage 304. The expression evaluator 66 may then operate on the received data using the constant. Further, the expression evaluator 66 may operate on the data while the ALUs 202 perform additional functions such as shader functions.

At block 410, the method 400 may optionally include outputting, by the expression evaluator to the processor, a final result based on the executed operations of the set of instructions. For example, as shown by FIG. 2, the expression evaluator 66 may provide the final result 270 to the ALUs 202.

At block 412, the method 400 may optionally include providing the final result of the executed operations of the set of instructions to a fixed function unit of a graphics processing unit (GPU). For example, as shown by FIG. 3, the ALUs 202 may provide the final result from the expression evaluator 66 to the texture sampler 224 or the output merger 226.

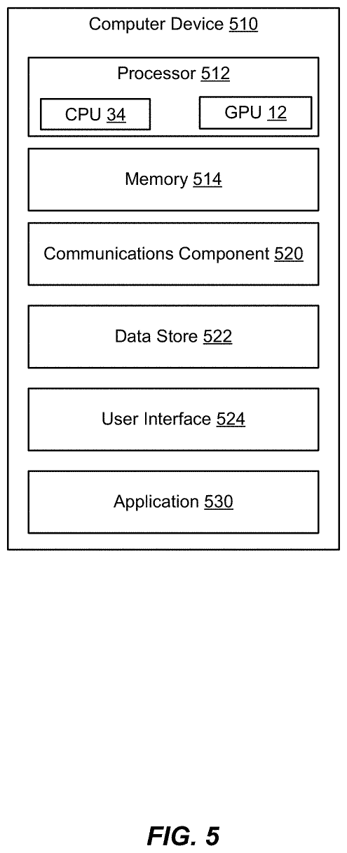

Referring to FIG. 5, illustrated is an example computer device 510 in accordance with an implementation, including additional component details as compared to FIG. 1. In one example, the computer device 510 may include the processor 512 for carrying out processing functions associated with one or more of components and functions described herein. The processor 512 may include a single or multiple set of processors or multi-core processors. Moreover, the processor 512 may be implemented as an integrated processing system and/or a distributed processing system. In an implementation, for example, the processor 512 may include the CPU 34 and/or the GPU 12 of FIG. 1. In an example, the computer device 510 may include memory 514 for storing instructions executable by the processor 510 for carrying out the functions described herein. In an implementation, for example, the memory 514 may include the memory 56 and/or the memory 58.

Further, the computer device 510 may include a communications component 520 that provides for establishing and maintaining communications with one or more parties utilizing hardware, software, and services as described herein. The communications component 520 may carry communications between components on the computer device 510, as well as between the computer device 510 and external devices, such as devices located across a communications network and/or devices serially or locally connected to the computer device 510. For example, the communications component 520 may include one or more buses, and may further include transmit chain components and receive chain components associated with a transmitter and receiver, respectively, operable for interfacing with external devices.

Additionally, the computer device 510 may include a data store 522, which can be any suitable combination of hardware and/or software, that provides for mass storage of information, databases, and programs employed in connection with implementations described herein. For example, the data store 522 may be a data repository for the applications 46, the GPU driver 48, and/or the graphics API 52.

The computer device 510 may also include a user interface component 524 operable to receive inputs from a user of the computer device 510 and further operable to generate outputs for presentation to the user. The user interface component 524 may include one or more input devices (e.g., input devices 51), including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 524 may include one or more output devices, including but not limited to a display (e.g., display 40), a speaker, a haptic feedback mechanism, a printer, any other mechanism capable of presenting an output to a user, or any combination thereof.

In an implementation, the user interface component 524 may transmit and/or receive messages corresponding to the operation of the applications 530. In addition, the processor 510 may execute the applications 530, and the memory 514, or the data store 522 may store them.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various examples are described herein in connection with a device (e.g., computer device 10), which can be a wired device or a wireless device. Such devices may include, but are not limited to, a gaming device or console, a laptop computer, a tablet computer, a personal digital assistant, a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various examples or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some examples, the processor and the storage medium may reside in an ASIC. Additionally, the ASIC may reside in a computer device (such as, but not limited to, a game console). In the alternative, the processor and the storage medium may reside as discrete components in a user terminal. Additionally, in some examples, the steps and/or actions of a method or algorithm may reside as one or any combination or set of codes and/or instructions on a machine readable medium and/or computer readable medium, which may be incorporated into a computer program product.

In one or more examples, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While examples of the present disclosure have been described in connection with examples thereof, it will be understood by those skilled in the art that variations and modifications of the examples described above may be made without departing from the scope hereof. Other examples will be apparent to those skilled in the art from a consideration of the specification or from a practice in accordance with examples disclosed herein.

What is claimed is:

1. A method of computer processing, comprising:
receiving instructions executable by a processor;
determining, by the processor, that a set of instructions of the received instructions is executable according to a restricted register mode in which the set of instructions relate to one or more single function operations that require no access to a register during execution of the one or more single function operations; and
executing, by an expression evaluator, operations of the set of instructions related to the one or more single function operations, wherein the executing is performed in the restricted register mode and in parallel with the processor performing arithmetic logic unit (ALU) operations of the instructions.

2. The method of claim 1, wherein determining the set of instructions is executable according to the restricted register mode includes identifying a syntax associated with the set of instructions that identifies that the set of instructions relate to the one or more single function operations.

3. The method of claim 1, wherein the single function operations are one or more of a single mathematical operand or a register copy operand.

4. The method of claim 1, further comprising:
outputting, by the expression evaluator to the processor, a final result based on the executed operations of the set of instructions.

5. The method of claim 4, further comprising:
providing, by the processor, the final result of the executed operations of the set of instructions to a fixed function unit of a graphics processing unit (GPU).

6. The method of claim 5, wherein the fixed function unit includes one of a texture sampler, a triangle rasterizer, ray-box intersector, ray-triangle intersector, or an output merger.

7. The method of claim 5, wherein the fixed function unit runs in parallel with the executing by the expression evaluator.

8. The method of claim 1, wherein the instructions comprise vertex data.

9. The method of claim 1, wherein the set of instructions includes a constant for an operation of the one or more single function operations.

10. The method of claim 1, further comprising:
receiving, from a register pool coupled with the processor, a constant for an operation of the one or more single function operations.

11. A computer system, comprising:
a processor; and
an expression evaluator coupled with the processor and configured to:
receive a first set of instructions from the processor, the first set of instructions executable according to a restricted register mode in which the set of instructions relate to one or more single function operations that require no access to a register during execution of the one or more single function operations;
execute operations of the first set of instructions in the restricted register mode and in parallel with the processor executing operations of a second set of instructions; and
send a final result to the processor based on the executed operations of the first set of instructions.

12. The computer system of claim 11, wherein the processor is configured to:
determine the first set of instructions is executable according to the restricted register mode when the first set of instructions relate to the one or more single function operations; and
send the first set of the instructions to the expression evaluator based on the first set of instructions being determined to be executable according to the restricted register mode.

13. The computer system of claim 11, wherein the one or more single function operations are one or more single mathematical operands or a register operands.

14. The computer system of claim 11, further comprising:
one or more fixed function units coupled with the processor are configured as one of a texture sampler, a triangle rasterizer, ray-box intersector, ray-triangle intersector, or an output merger, wherein the processor provides the final result to the one or more fixed function units.

15. The computer system of claim 11, wherein the processor includes one or more arithmetic logic units (ALUs).

16. The computer system of claim 11, wherein the processor is a single instruction multiple data (SIMD) processor.

17. The computer system of claim 11, wherein the processor is graphics processing unit (GPU).

18. The computer system of claim 11, wherein the first set of instructions includes a constant for an operation of the one or more single function operations.

19. The computer system of claim 11, further comprising a register pool coupled with the processor, wherein the expression evaluator is further configured to receive, from the register pool, a constant for an operation of the one or more single function operations.

20. A computer-readable storage medium storing instructions for computer processing, the instructions executable by one or more processors, comprising:
at least one instruction for causing a processor to receive restricted register instructions executable by a processor;
at least one instruction for causing the processor to determine that a set of instructions of the restricted register instructions is executable according to a restricted register mode in which the set of instructions relate to one or more single function operations that require no access to a register during execution of the one or more single function operations; and
at least one instruction for causing the processor to execute operations of the set of instructions related to the one or more single function operations, wherein the executing is performed in the restricted register mode and in parallel with the processor performing additional operations of the restricted register instructions,
wherein the executing is performed in the restricted register mode and in parallel with the processor performing additional operations of the restricted register instructions.
